(19) United States
(12) Patent Application Publication
(10) Pub. No.: US 2014/0151994 A1
(43) Pub. Date: Jun. 5, 2014

(54) DISPLAY FOR DOCUMENTS OR INFORMATION CONTAINED IN TRANSPARENT POUCHES OR OTHER SIMILAR ELEMENTS

(71) Applicants: Benjamin Baruteaud, Strasbourg (FR); Jean-Marc Barthel, Strasbourg (FR)

(72) Inventors: Benjamin Baruteaud, Strasbourg (FR); Jean-Marc Barthel, Strasbourg (FR)

(73) Assignee: TARIFOLD (SOCIETE PAR ACTIONS SIMPLIFIEE), Geispolsheim (FR)

(21) Appl. No.: 14/131,089

(22) PCT Filed: Jul. 4, 2012
(86) PCT No.: PCT/FR2012/051560

§ 371 Date: Jan. 6, 2014

(30) Foreign Application Priority Data
Jul. 5, 2011 (FR) 1156057

(51) Int. Cl. B42D 17/00

(52) U.S. Cl. CPC B42D 17/00
USPC 281/45

(57) ABSTRACT

A display for documents or information contained in transparent pouches (2) or other similar elements, includes at least one assembly composed of a row of pouches (2) and a support (1) including a system (3) for holding the row of pouches (2) on the support (1), each pouch (2) having a fastening and pivoting side (4) provided with at least one pivoting element (5), the holding system (3) being arranged such as to allow each pouch (2) to be fastened removably and to be pivoted in the manner of the pages of a book. The holding system (3) consists of at least one magnetic fastening site (3) that is able to retain the pivoting element(s) (5) of each pouch (2) by magnetism and to enable transverse movement of the fastening and pivoting side (4).

This invention relates to the field of display stands for documents, and it has as its object a display stand for documents or information contained in transparent pockets or other similar elements.

Display stands for documents equipped with transparent pockets containing said documents and each mounted in a pivoting fashion are already known. In general, they comprise at least one unit composed of a row of pockets and a support comprising a system for receiving the row of pockets on the support. Each pocket has an attachment and pivoting side equipped with at least one pivoting element, and the receiving system is arranged to receive and hold, in a detachable way, the pivoting element or elements of each pocket on the support, in such a way as to allow the detachable attachment and the pivoting, in the manner of the pages of a book, of each pocket on the support.

In general, such pockets each consist of a transparent envelope, of an overall rectangular shape, stiffened over its periphery and comprising, in the axial extension or at the level of each end of the attachment and pivoting side, forming one of the sides of the corresponding pocket, two pivots together forming the pivoting axis of the corresponding pocket attached to the support.

Among the pockets used in these display stands, there are known, for example, pockets with a single container designed to receive a document and pockets with several containers attached to one of the external surfaces of the pocket and in general designed to receive disks, Cds or other computer information media or multimedia.

In contrast, the support of these display stands is in general of the desk or mural type and consists of a simple metal plate equipped with a base for its support on a display surface or attached to a wall, while the upper and lower edges of said plate are each folded essentially at a right angle and each comprise—in the folded part—a row of holes each designed to receive one of the pivots of a pocket.

Other known display stands consist of a support made of plastic material comprising two end pieces that are suitable for receiving pivots that are integral with the attachment and pivoting side of each pocket.

However, the male/female connecting system, of the hinge type, used in these display stands for attaching and articulating by pivoting the pockets has numerous drawbacks.

First of all, the installation of a pocket on the support at a mounting point of the row already occupied by another pocket requires the removal of said pocket and then its staggering with the other pockets following or preceding the latter, along the row, requiring the removal and then the installation of said pockets to be staggered.

In contrast, the removal or the installation of a pocket requires a shift of its pivoting axis along several axes, with slopes, and finding the corresponding hole in the support for inserting the corresponding pivot.

This invention has as its object to remedy these drawbacks by proposing a display stand for documents or information contained in transparent pockets or other similar elements, making possible a quick and simple installation and removal of said pockets, as well as an installation of a pocket at any location occupied by another pocket of the row, at one end or between two successive pockets, with a natural shift of the other pockets of the row.

For this purpose, this invention has as its object a display stand for documents or information contained in transparent pockets or other similar elements, comprising at least one unit composed of a row of pockets and a support comprising a system for receiving the row of pockets on the support, each pocket having an attachment and pivoting side equipped with at least one pivoting element, with the receiving system being arranged to receive and to hold, in a detachable fashion, the pivoting element or elements of each pocket on the support, thereby making possible the detachable attachment and the pivoting, in the manner of the pages of a book, of each pocket on the support.

Such a device is characterized essentially in that for each unit, the receiving system consists of at least one magnetic attachment site comprising magnetic attachment means that by magnetic attraction are capable of holding the—or one of the—element(s) for pivoting each pocket on the support and/or at least one mechanical attachment site comprising mechanical attachment means that are capable of mechanically holding one—or one of the—element(s) for pivoting each pocket on the support and in that the receiving system is capable of allowing, in the attachment state, a transverse shift of the attachment and pivoting side of each pocket on the support.

The invention will be better understood thanks to the description below, which relates to a preferred embodiment, provided by way of non-limiting example and explained with reference to the accompanying schematic drawings, in which:

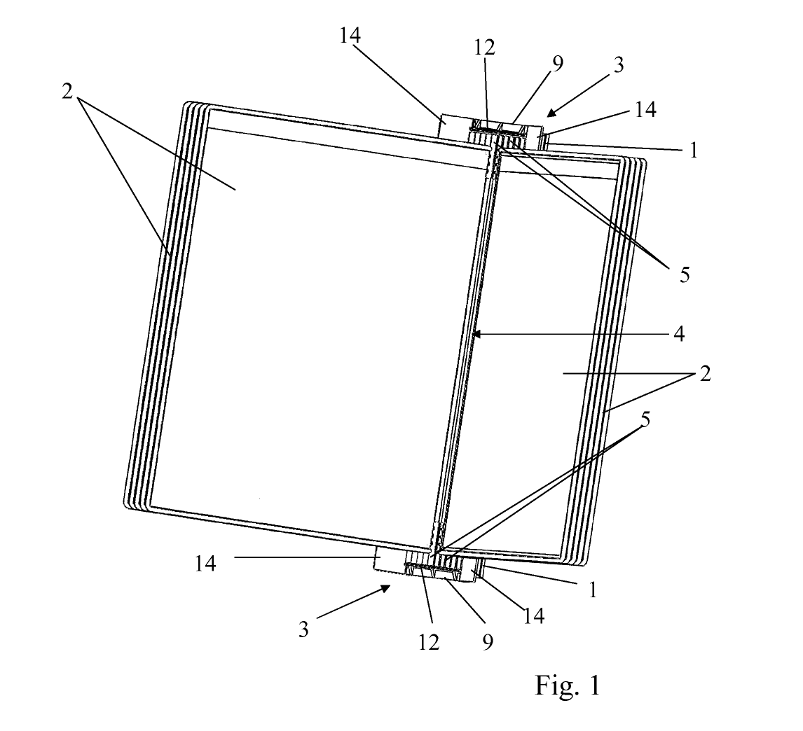

FIG. 1 shows a perspective view of a display stand, according to this invention, comprising a unit in one preferred embodiment,

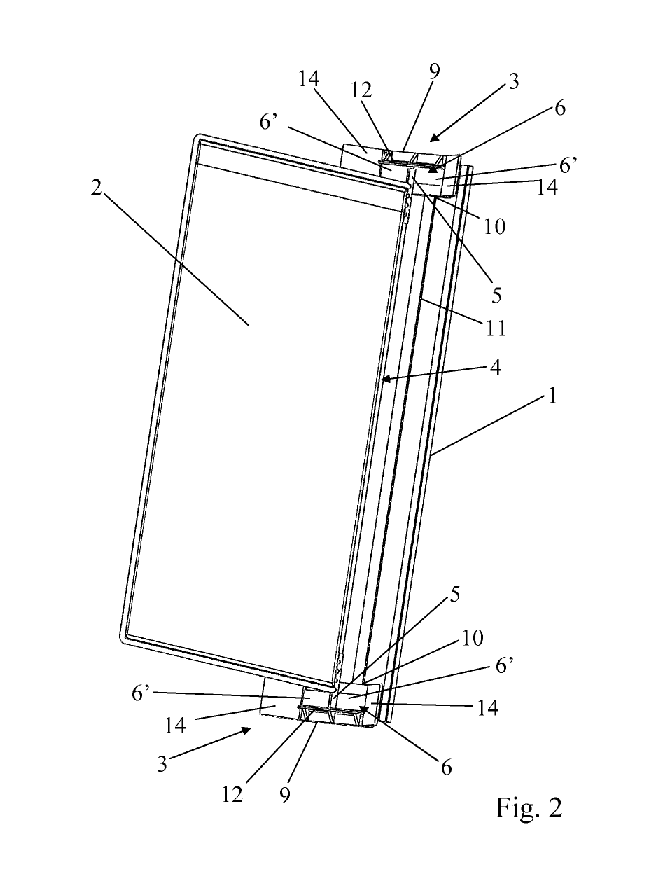

FIG. 2 shows the display stand shown in FIG. 1 with a single pocket attached to the support,

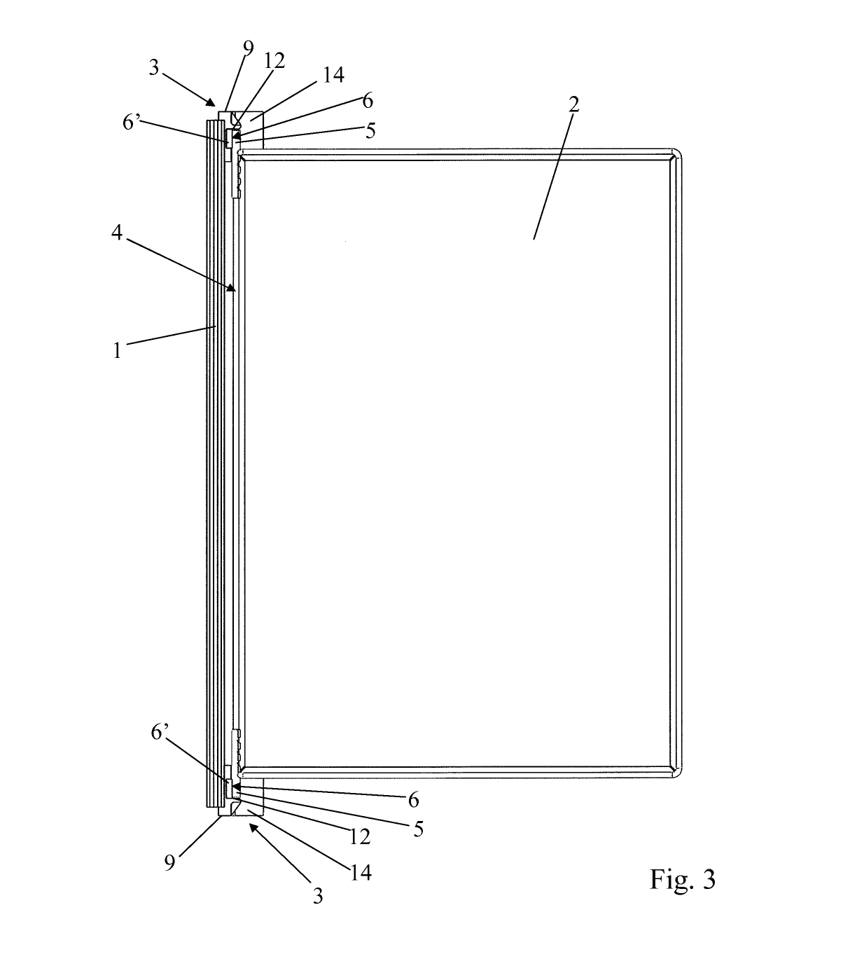

FIG. 3 shows a transverse cutaway view of the display stand shown in FIG. 2 with a profile view of the pocket attached to the support,

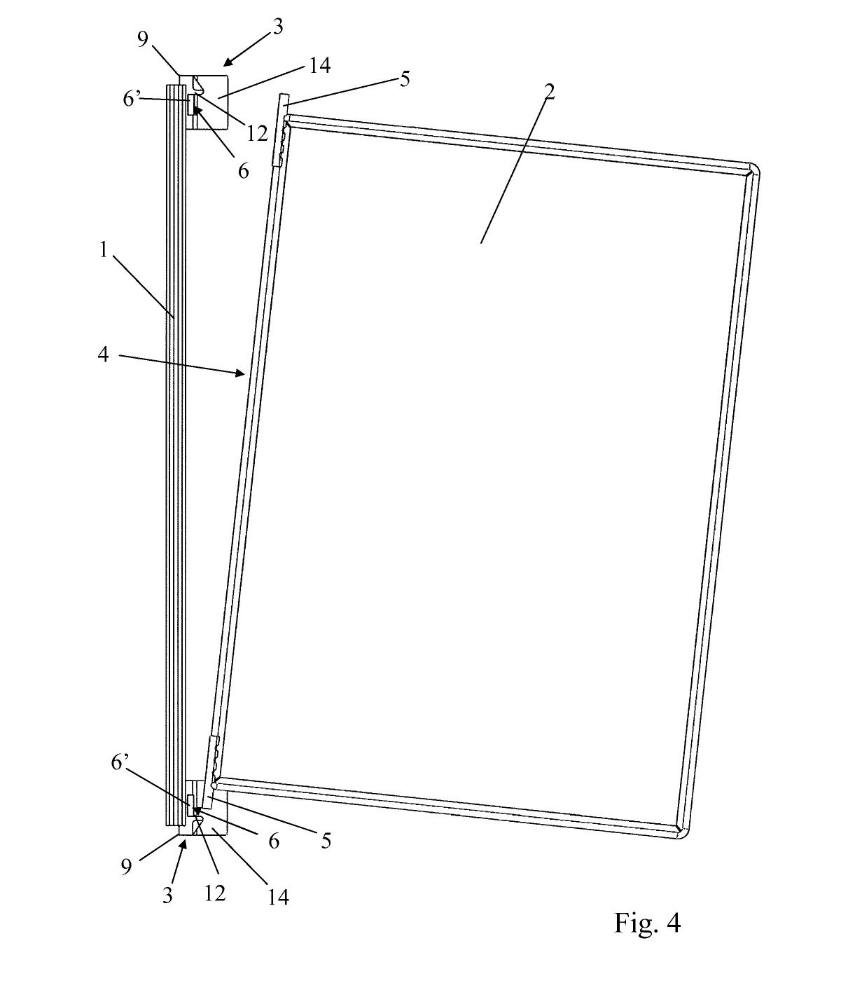

FIG. 4 shows the display stand shown in FIG. 2, in the phase where the pocket is being attached to the support,

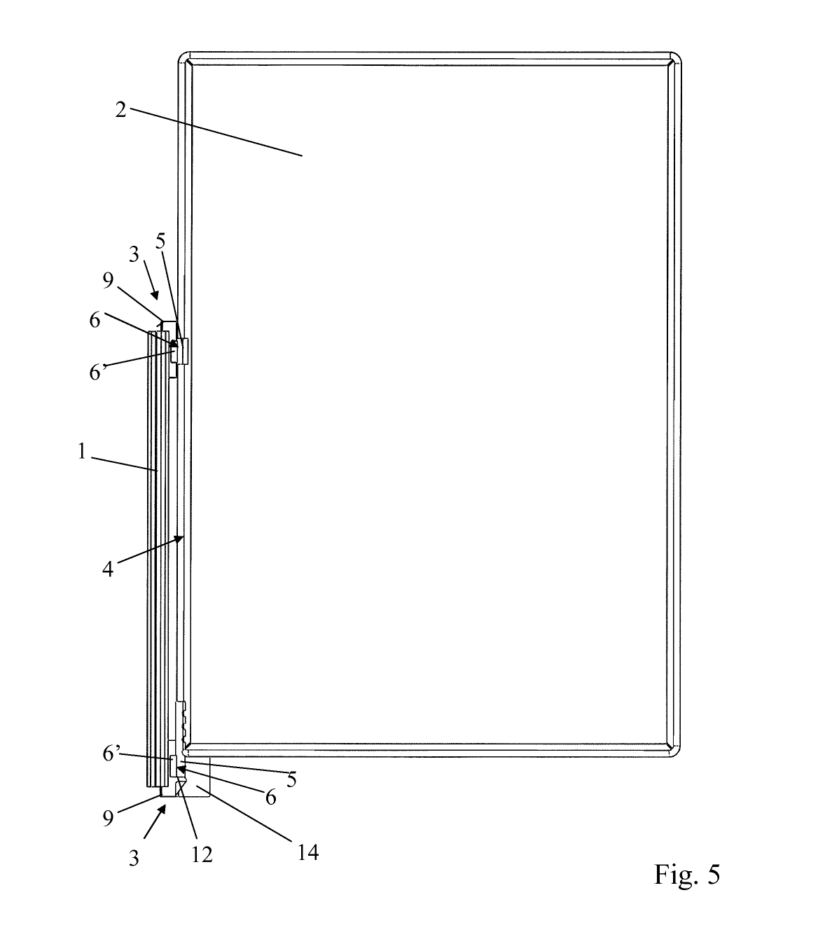

FIG. 5 shows a variant of the display stand shown in FIG. 3,

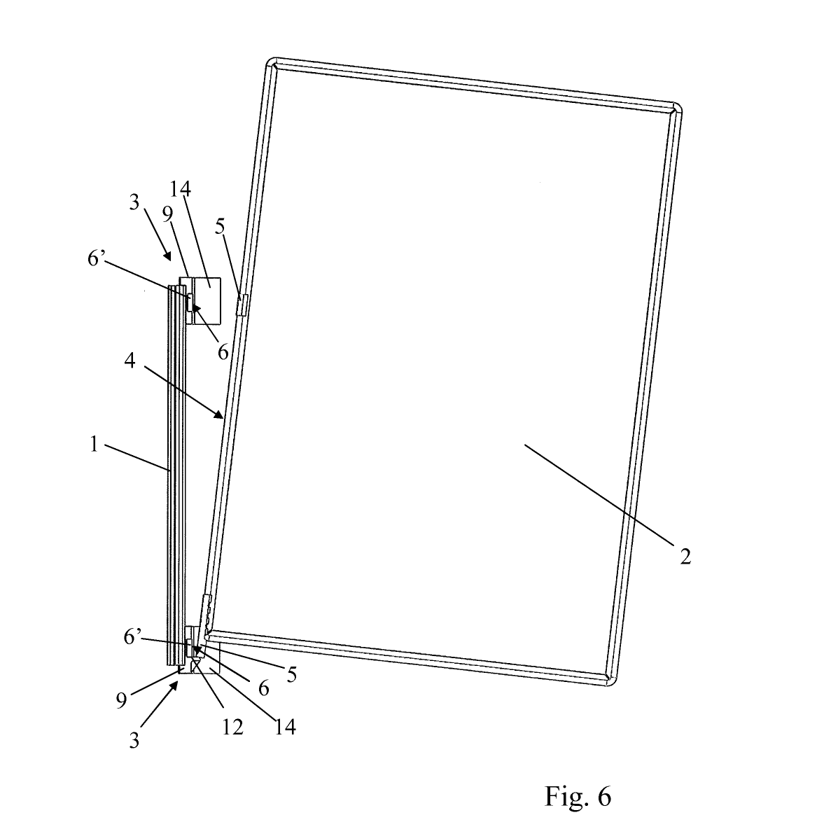

FIG. 6 shows the display stand shown in FIG. 5, in the phase where the pocket is being attached to the support,

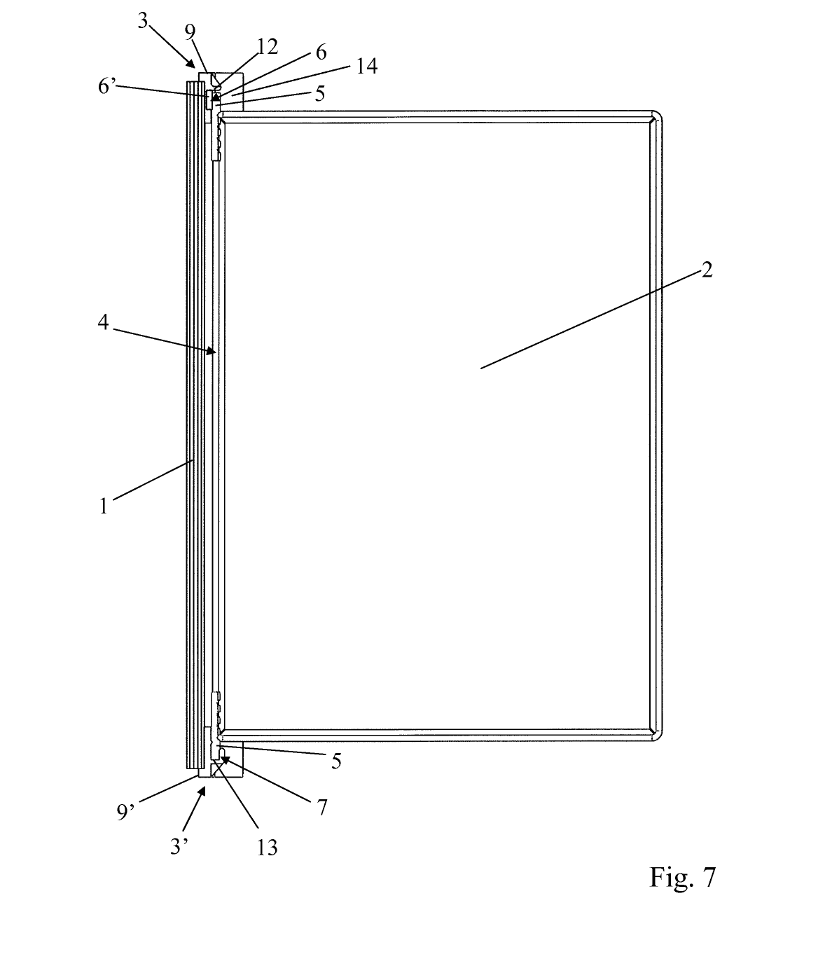

FIG. 7 shows the display stand shown in FIG. 2 in a variant of the receiving system,

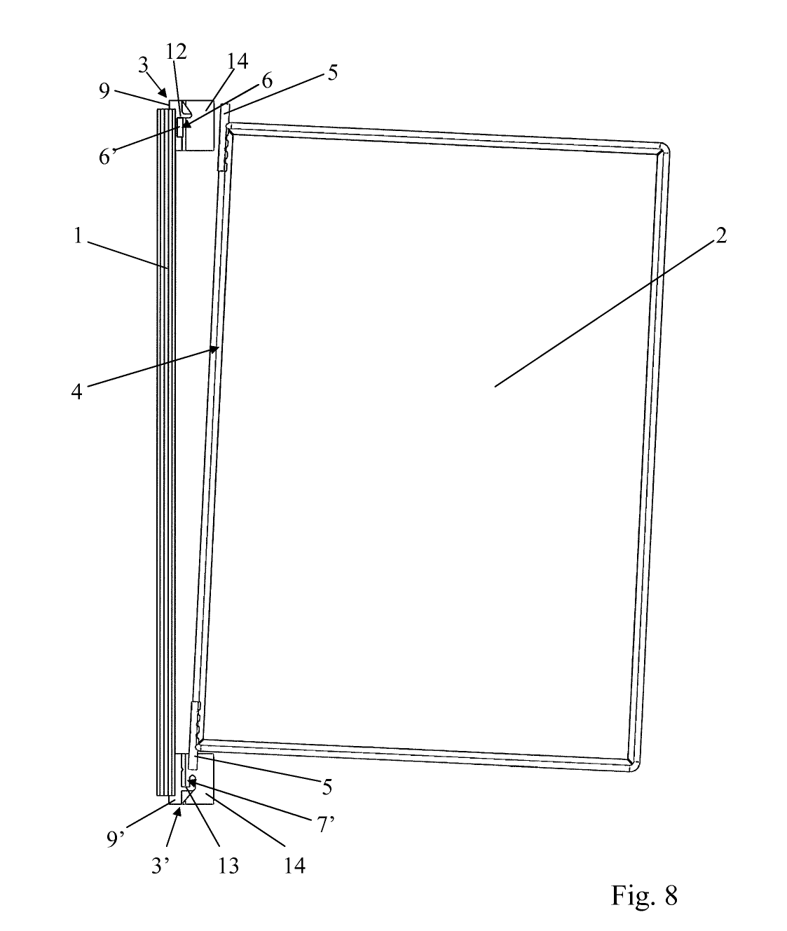

FIG. 8 shows the display stand shown in FIG. 7, in the phase where the pocket is being attached to the support,

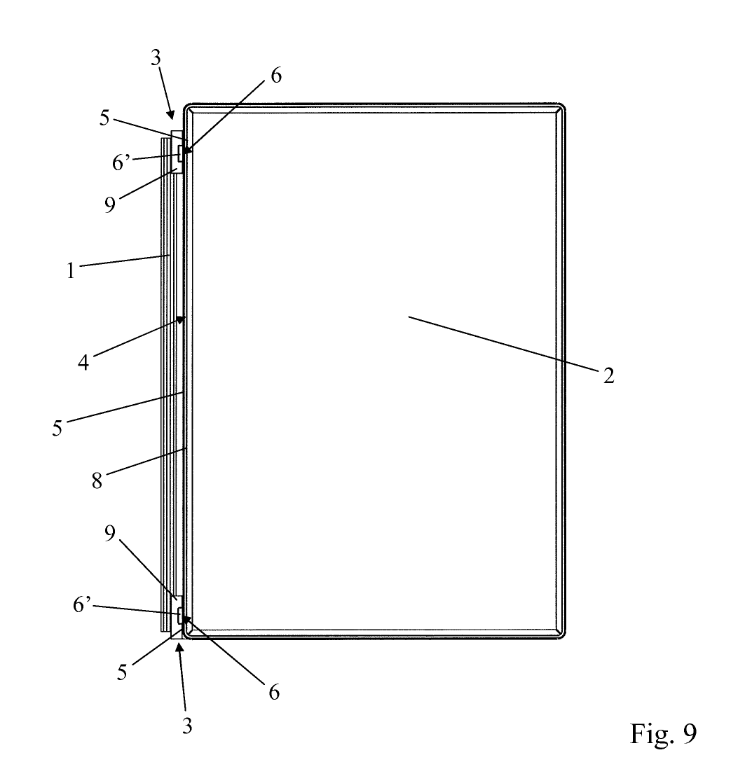

FIG. 9 shows a transverse cutaway view of a display stand comprising a unit, according to this invention, in another embodiment,

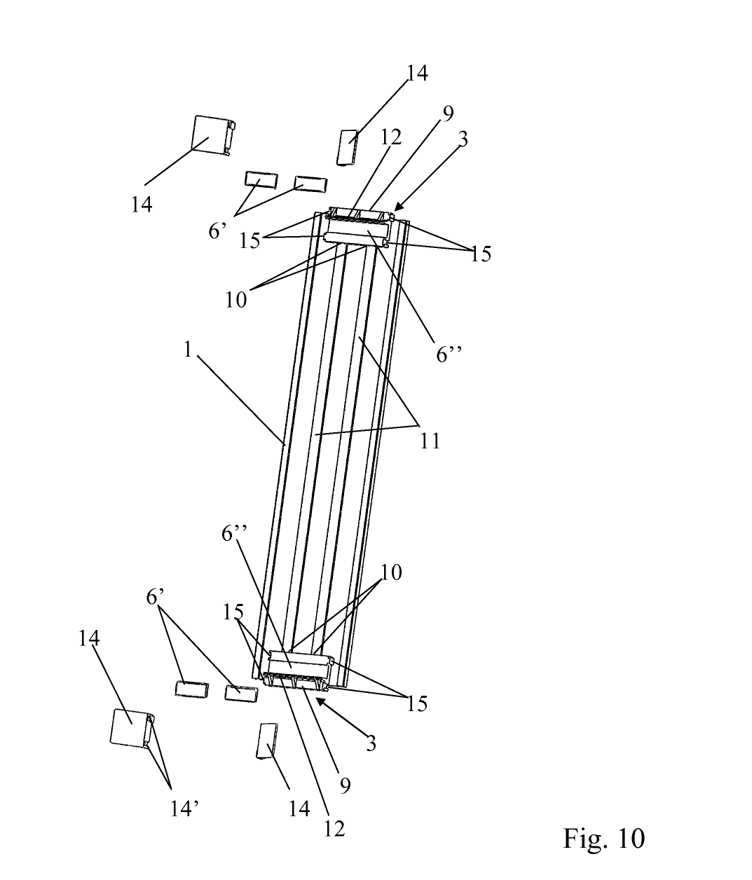

FIG. 10 shows a perspective and exploded view of the support and of the receiving system shown in FIG. 1,

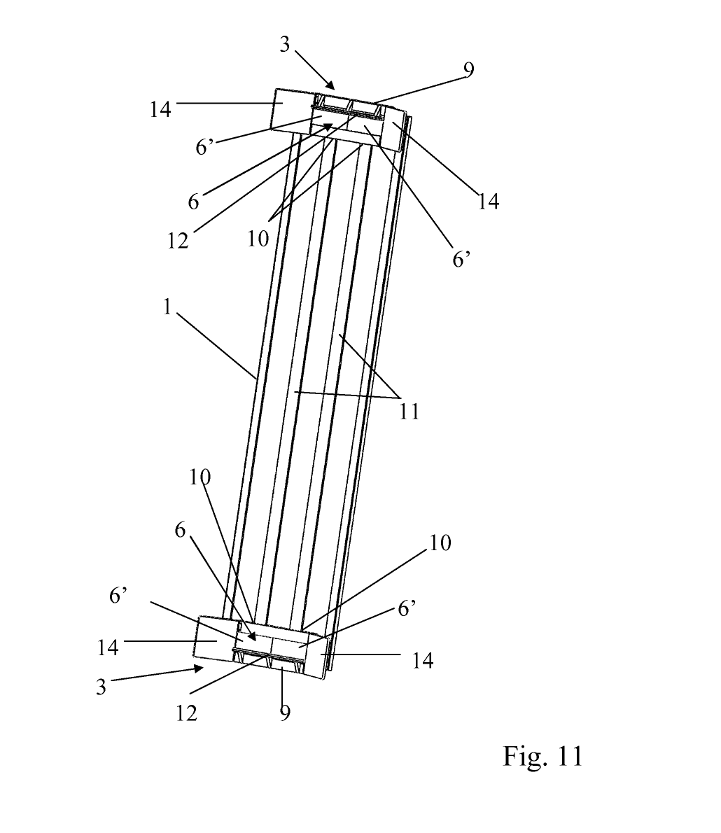

FIG. 11 shows the support and the receiving system shown in FIG. 10 in the assembled state of their constituent elements.

The figures show a display stand, according to this invention, for documents or information contained in transparent pockets 2 or other similar elements, comprising at least one unit composed of a row of pockets 2 and a support 1 comprising a system 3 and/or 3′ for receiving the row of pockets 2 on the support, each pocket 2 having an attachment and pivoting side 4 equipped with at least one pivoting element 5, with the receiving system 3 and/or 3′ being arranged to receive and hold, in a detachable fashion, the pivoting element or elements 5 of each pocket 2 on the support 1, in such a way as to make possible the detachable attachment and the pivoting, in the manner of the pages of a book, of each pocket 2 on the support 1.

In accordance with this invention, for each unit, the receiving system 3 and/or 3′ consists of at least one magnetic attachment site 3 comprising magnetic attachment means 6 that by magnetic attraction are capable of holding the—or one of the—pivoting element(s) 5 of each pocket 2 on the support 1 and/or at least one mechanical attachment site 3′ (FIGS. 7 and 8) comprising mechanical attachment means 7 that are capable of mechanically holding the—or one of the—pivoting element(s) of each pocket 2 on the support 1.

In each case according to this invention, the receiving system 3 is capable of allowing, in the attachment state, a transverse shift of the attachment and pivoting side 4 of each pocket 2 on the support 1.

Transverse shift of the attachment and pivoting side 4 of each pocket 2 will be defined as a shift of the latter essentially parallel to the longitudinal axis of the corresponding row of pockets.

Such a transverse shift then makes possible, contrary to the current display stands, the installation of a pocket on the support 1, at the location of the row that is already occupied by another pocket, by staggering the pockets following or preceding said location, simply by transverse sliding of the latter and more particularly their pivoting element(s) in the corresponding attachment sites along the row.

In one preferred embodiment of the magnetic attachment means 6 of the—or of each—magnetic attachment site 3, the latter can consist of a metallic or magnetic surface of magnetic attachment and lateral shift that by magnetic attraction are capable of holding the—or one of the—pivoting element(s) 5 against the surface of magnetic attachment and lateral shift 6, while making possible the lateral sliding of the pivoting element in question on the surface of magnetic attachment and lateral shift 6 in such a way as to allow, in the attachment state, the transverse shift of the attachment and pivoting side 4 of each pocket 2.

The surface of magnetic attachment and lateral shift 6 of each magnetic attachment site 3 can extend continuously or intermittently and can have a shape, for example, that is preferably flat or grooved, honeycombed, curved or rounded, or a combination of these shapes.

Thus, in the case where the receiving system comprises a number of surfaces of magnetic attachment and lateral shift 6 of a flat shape, said flat surfaces can extend essentially into the same plane.

Preferably, the surface of magnetic attachment and lateral shift 6 of the—or of each—magnetic attachment site 3 can be made of a magnet or a juxtaposition of magnets 6′ each coming, for example, in the form of a small plate, of which one of the large surfaces forms, at least partially, said surface 6 (in particular FIG. 10 and FIG. 11).

It will be noted that such a magnetic attachment mode of the pockets 2 on the support 1 of a unit of a display stand according to this invention makes it possible to keep the attachment and pivoting side 4 of each pocket 2 along an axis that is essentially perpendicular to the longitudinal axis of the corresponding row of pockets 2 and to prevent the attachment and pivoting sides 4, which are, in some ways, magnetically glued to the support 1, from being inclined in the attachment state, in particular in the event where all of the pockets are not attached to the support 1.

In one preferred embodiment of the mechanical attachment means of the—or of each—mechanical attachment site 3′, as can be seen in FIG. 7 and in FIG. 8, the latter can consist of a mechanical attachment groove 7 that extends crosswise, i.e., essentially parallel, to the longitudinal axis of the corresponding row of pockets 2, and that is capable of receiving and holding mechanically, in the groove 7, the—or one of the—pivoting element(s) 5 of each pocket 2, while making it possible for said pivoting element 5 to slide in the groove 7 in such a way as to allow, in the attachment state, the transverse shift of the attachment and pivoting side 4 of the pocket 2 in question.

In a first embodiment, each pocket 2 can comprise a single pivoting element 5, and the receiving system can consist of, in a first embodiment, not shown, a single magnetic attachment site 3 that is capable of receiving and holding, by itself, said pivoting element 5, which is at least partly metallic or magnetic. In a second embodiment of the receiving system, the latter can consist of at least two magnetic attachment sites 3, each one capable of receiving and holding, partially, said pivoting element 5, which is at least partly metallic or magnetic (FIG. 9). In a third embodiment, not shown, of the receiving system, the latter can consist of two mechanical attachment sites 3′, each one capable of receiving and holding, partially, said pivoting element 5. Finally, in a fourth embodiment, also not shown, of the receiving system, the latter can consist of at least one magnetic attachment site 3, capable of receiving and holding, partially, said pivoting element 5, and a mechanical attachment site 3′, capable of receiving and holding, partially, said pivoting element 5.

In a second embodiment or preferred embodiment, each pocket 2 can be equipped with two pivoting elements 5, and the receiving system can consist of, in a first embodiment, two magnetic attachment sites 3, each one capable of receiving and holding, by itself, one of the two pivoting elements 5, which is at least partly metallic or magnetic, of each pocket 2 (FIGS. 1, 2, 3, 4, 5, 6). In a second embodiment, not shown, of the receiving system, the latter can consist of two mechanical attachment sites 3′, each one capable of receiving and holding, by itself, one of the two pivoting elements 5. In a third embodiment of the receiving system 3, the latter can consist of a magnetic attachment site 3, capable of holding, by itself, one of the two pivoting elements 5, which is at least partly metallic or magnetic, of each pocket 2 and a mechanical attachment site 3′, capable of holding, by itself, the other pivoting element 5 of each pocket 2 (FIGS. 7 and 8).

It will be understood that in the case of a mechanical attachment site, the pivoting element that is capable of being received and held by the latter can be made of any rigid material, including a metallic or magnetic material, and that said element can comprise at least one engagement end, if necessary, in the groove of the mechanical attachment site 3′ in question.

Preferably, in the case where each pocket of said unit is equipped with two pivoting elements 5, one of the two pivoting elements 5 can extend at the level of and/or beyond one of the two ends of the corresponding attachment and pivoting side 4, and the other pivoting element 5 can extend essentially at the level of the other end of the corresponding attachment and pivoting side 4 (FIGS. 1, 2, 3, 4, 7, 8) or at the level of the median part of the latter (FIG. 5 and FIG. 6).

In a preferred embodiment, the—or each—pivoting element 5 of each pocket 2 can consist of a pivot or another elongated element, preferably in an overall cylindrical or polygonal shape, extending essentially parallel to the corresponding attachment and pivoting side 4, whereby said pivot 5 is made, if necessary, at least partially, of a metallic or magnetic material for the purpose of carrying out its attachment to the support 1 by magnetic attraction.

Preferably, each pivot 5 can extend either at the level of and/or beyond, i.e., at the level of or at the level of and beyond, one of the two ends of the corresponding attachment and pivoting side 4 as can be seen in particular in FIGS. 1, 2, 3 and 4, where each pivot 5 axially exceeds the corresponding end.

Each pivot can be provided for having a diameter that is larger than the thickness of the pockets 2 and in particular from the attachment side of the latter in such a way as to be able to touch and to form, with the magnets 6′ receiving them, a cohesive unit making it possible to improve the effectiveness of the display stand (FIG. 1).

Furthermore, the diameter of the metallic pivots 5 can be adapted by being large enough or high enough to make possible a larger exchange or contact surface with the magnets 6′ and therefore a stronger attraction, in such a way as to also improve the effectiveness of the display stand. In contrast, the magnets 6′ can be adapted, for example in thickness, for optimizing their force of attraction of the metallic pivots 5.

The position of the pivots 5 at the two ends of each pocket 2, i.e., one pivot 5 per end, imparts maximum stability to the display stand.

Thus, the use of such pivots 5 makes possible a total opening of pockets, a use of the entire reading surface, and a reduction of the space requirement of the unit.

In a third embodiment, the attachment and pivoting side 4 of each pocket 2 can form, as such, a pivoting element 5, which is at least partly metallic or magnetic, and the receiving system 3 can consist of a single magnetic attachment site 3, capable of receiving and holding, by itself, said attachment and pivoting side 4 of each pocket 2. In addition, in a variant, the receiving system 3 can consist of at least two magnetic attachment sites 3, each one capable of receiving and holding, partially, the attachment and pivoting side 4 forming a pivoting element 5 of each pocket 2 (FIG. 9).

In this third embodiment, this invention can provide, in a first embodiment (FIG. 9) of the attachment and pivoting side 4 of each pocket 2, that at least one wire 8, or another elongated, metallic or magnetic element, is to be integrated into or embedded in the attachment and pivoting side 4 of each pocket 2, with the—or each—wire extending longitudinally over all or part of the length of the corresponding attachment and pivoting side 4.

In each case in this third embodiment, this invention can provide in a second embodiment, not shown, of the attachment and pivoting side 4 of each pocket 2 that the external longitudinal edge of the attachment and pivoting side 4 of each pocket 2 is made, at least partially, of a metallic or magnetic material, with said longitudinal edge forming, as such, the pivoting element 5.

Preferably, the—or each—magnetic attachment site 3, or mechanical attachment site 3′, can consist of a single piece 9, or 9′, preferably made of plastic material, able to comprise two opposite surfaces, of which one of said opposite surfaces can comprise the magnetic attachment means 6, or mechanical attachment means 7, and the other opposite surface can comprise connecting means 10 making possible its preferably detachable attachment to the support 1.

More specifically, it is possible to see in FIG. 10 that each single piece 9 of a magnetic attachment site 3 can comprise a housing 6″ that is suitable for receiving one or more magnets 6′ able to form the corresponding surface of magnetic attachment and lateral shift 6.

Furthermore, the connecting means 10 of the—or of each—single piece 9, or 9′, can consist of male or female elastic interlocking means (in particular FIG. 10), preferably reversible, such as, for example, at least one groove, for example with a C-shaped transverse cross-section, capable of working with complementary male or female elastic interlocking means 11, such as, for example, at least one rib, for example with a T-shaped transverse cross-section, integral with the support 1.

In contrast, this invention can provide that at least one magnetic attachment site 3, or at least one mechanical attachment site 3′, comprises an axial stop 12, or 13, making it possible to block or to limit the axial translation of the attachment and pivoting side 4 of each pocket 2, in the state of attachment to the support 1.

In a preferred embodiment of the axial stop 12 of a magnetic attachment site 3, the latter can consist of a support surface or stop, for example the longitudinal surface of a bar or a block, extending crosswise (figures, except for FIG. 9), and, if necessary, in a preferred embodiment of the axial stop 13 of a mechanical attachment site 3′, the latter can consist of the bottom of the groove 7 (FIG. 7 and FIG. 8).

More particularly, this invention can preferably provide an axial stop 12 or 13 in the low part of the receiving system 3 and/or 3′ in such a way as to prevent the sliding of each pocket 2 downward, more particularly by gravity.

More specifically, it is possible to see in FIG. 10 that the—or each—surface of magnetic attachment and lateral shift 6 can have a rectangular shape comprising two large sides that are essentially parallel to the longitudinal axis of the corresponding row of pockets 2 and that the—or one of the—bar(s) or block(s), comprising the support surface 12, of a magnetic attachment site 3 can extend along one of the large sides of the corresponding surface of magnetic attachment and lateral shift 6, with said support surface 12 then extending in a plane that is essentially perpendicular to the corresponding surface of magnetic attachment and lateral shift 6.

This invention can provide lateral stops 14 that are attached, preferably in a detachable fashion, to the support 1 and that extend laterally from both sides of the—or of at least one of the—magnetic attachment site(s) 3, or mechanical attachment site(s) 3′, in such a way as to make possible the lateral holding of the pockets 2 that are attached to the support 1 in an open state in the manner of an open book (FIG. 1). Such lateral stops 14, for example in the form of a small plate or a lug, can be attached in a detachable fashion to the—or to multiple—single piece(s) 9, or 9′, in question, for example to the lateral surfaces of the latter, and can comprise for this purpose, for example on one of their lateral surfaces, male or female elastic interlocking elements 14′ that are capable of working with complementary elastic interlocking elements 15 made in the lateral surfaces of said single pieces (FIG. 10).

Of course, the invention is not limited to the embodiment described and shown in the accompanying drawings. Modifications remain possible, in particular from the standpoint of the composition of the various elements or by substitution of technical equivalents, without thereby exceeding the field of protection of the invention.

1. Display stand for documents or information contained in transparent pockets (2) or other similar elements, comprising at least one unit composed of a row of pockets (2) and a support (1) comprising a system (3) and/or (3′) for receiving the row of pockets (2) on the support (1), each pocket (2) having an attachment and pivoting side (4) equipped with at least one pivoting element (5), with the receiving system (3) and/or (3′) being arranged to receive and hold, in a detachable fashion, the pivoting element or elements (5) of each pocket (2) on the support (1), in such a way as to make possible the detachable attachment and the pivoting, in the manner of the pages of a book, of each pocket (2) on the support (1),
display stand characterized in that, for each unit, the receiving system (3) and/or (3′) consists of at least one magnetic attachment site (3) comprising magnetic attachment means (6) that by magnetic attraction are capable of holding the—or one of the—pivoting element(s) (5) of each pocket (2) on the support (1) and/or at least one mechanical attachment site (3′) comprising mechanical attachment means (7) that are capable of mechanically holding the—or one of the—pivoting element(s) of each pocket (2) on the support (1), and in that the receiving system (3) and/or (3′) is capable of allowing, in the attachment state, a transverse shift of the attachment and pivoting side (4) of each pocket (2) on the support (1).

2. Display stand, according to claim 1, wherein the magnetic attachment means of the—or of each—magnetic attachment site (3) consist of a metallic or magnetic surface of magnetic attachment and lateral shift (6) that by magnetic attraction are capable of holding the—or one of the—pivoting element(s) (5) against said surface, while making possible the lateral sliding of the pivoting element (5) in question on said surface in such a way as to allow, in the attachment state, the transverse shift of the attachment and pivoting side (4) of the pocket (2) in question.

3. Display stand, according to claim 2, wherein the surface of magnetic attachment and lateral shift (6) of the—or of each—magnetic attachment site (3) is made of a magnet (6′) or a juxtaposition of magnets (6′) each coming in the form of a small plate, of which one of the large surfaces forms, at least partially, said surface (6).

4. Display stand, according to claim 1, wherein the means for mechanical attachment of the—or of each—mechanical attachment site (3′) consist of a mechanical attachment groove (7) extending crosswise and being capable of receiving and holding mechanically, in the latter, the—or one of the—pivoting element(s) (5) of each pocket (2), while making it possible for said pivoting element (5) to slide in the groove (7) in such a way as to allow, in the attachment state, the transverse shift of the attachment and pivoting side (4) of the pocket (2) in question.

5. Display stand, according to claim 1, wherein each pocket (2) comprises a single pivoting element (5) and wherein the receiving system (3) consists either of a single magnetic attachment site (3), capable of receiving and holding, by itself, said pivoting element (5), which is at least partly metallic or magnetic, or at least two magnetic attachment sites (3), each one capable of receiving and holding, partially, said pivoting element (5), which is at least partly metallic or magnetic, or two mechanical attachment sites (3′), each one capable of receiving and holding, partially, said pivoting element (5), or at least one magnetic attachment site (3), capable of receiving and holding, partially, said pivoting element (5), and a mechanical attachment site (3′), capable of receiving and holding, partially, said pivoting element (5).

6. Display stand, according to claim 1, wherein each pocket (2) is equipped with two pivoting elements (5) and wherein the receiving system consists either of two magnetic attachment sites (3), each one capable of receiving and holding, by itself, one of the two pivoting elements (5), which is at least partly metallic or magnetic, of each pocket (2), or two mechanical attachment sites (3′), each one capable of receiving and holding, by itself, one of the two pivoting elements (5) of each pocket (2), or a magnetic attachment site (3), capable of receiving and holding, by itself, one of the two pivoting elements (5), which is at least partly metallic or magnetic, of each pocket (2), and a mechanical attachment site (3′), capable of receiving and holding, by itself, the other pivoting element (5) of each pocket (2).

7. Display stand, according to claim 6, wherein one of the two pivoting elements (5) of each pocket (2) extends at the level of and/or beyond one of the two ends of the corresponding attachment and pivoting side (4), and the other pivoting element (5) of each pocket (2) extends essentially at the level of the other end of the corresponding attachment and pivoting side (4) or at the level of the median part of the latter.

8. Display stand, according to claim 1, wherein the—or each—pivoting element (5) of each pocket (2) consists of a pivot or another elongated element, of an overall cylindrical or polygonal shape, extending essentially parallel to the corresponding attachment and pivoting side (4), whereby said pivot (5) is made, if necessary, at least partially, of a metallic or magnetic material.

9. Display stand, according to claim 1, wherein the attachment and pivoting side (4) of each pocket (2) forms, as such, a pivoting element (5), which is at least partly metallic or magnetic, and wherein the receiving system (3) consists either of a single magnetic attachment site (3), capable of receiving and holding, by itself, said attachment and pivoting side (4), or at least two magnetic attachment sites (3), each one capable of receiving and holding, partially, the attachment and pivoting side (4) of each pocket (2).

10. Display stand, according to claim 9, wherein at least one wire (8), or another elongated metallic or magnetic element, is integrated into or embedded in the attachment and pivoting side (4) of each pocket (2), with the—or each—wire extending longitudinally over all or part of the length of the corresponding attachment and pivoting side (4).

11. Display stand, according to claim 10, wherein the external longitudinal edge of the attachment and pivoting side (4) of each pocket (2) is made, at least partially, of a metallic or magnetic material, with said longitudinal edge forming, as such, a pivoting element (5).

12. Display stand, according to claim 1, wherein the—or each—magnetic attachment site (3), or mechanical attachment site (3′), consists of a single piece (9), or (9′), preferably made of plastic material, comprising two opposite surfaces, of which one of said opposite surfaces comprises the magnetic attachment means (6) or mechanical attachment means (7), and the other opposite surface comprises connecting means (10) that make possible its preferably detachable attachment to the support (1).

13. Display stand, according to claim 12, wherein the connecting means (10) of the—or of each—single piece (9) consist of male or female elastic interlocking means, preferably reversible, such as, for example, at least one groove, able to work with complementary male or female elastic interlocking means (11), such as, for example, at least one rib, integral with the support (1).

14. Display stand, according to claim 1, wherein at least one magnetic attachment site (3), or at least one mechanical attachment site (3′), comprises an axial stop (12), or (13), making it possible to block or to limit the axial translation of the attachment and pivoting side (4) of each pocket (2) in the attachment state on the support (1).

15. Display stand, according to claim 14, wherein the axial stop (12) of a magnetic attachment site (3′) consists of a support surface or stop extending crosswise and wherein, if necessary, the axial stop (13) of a mechanical attachment site (3′) consists of the bottom of the groove (7′).

16. Display stand, according to claim 1, wherein it comprises lateral stops (14) that are attached, preferably in a detachable fashion, to the support (1) and that extend laterally on both sides of the—or of at least one of the—magnetic attachment site(s) (3), or mechanical attachment sites (3′), in such a way as to make possible the lateral holding of pockets (2) that are attached to the support (1) in an open state in the manner of an open book.
